(19) United States
(12) Patent Application Publication
(10) Pub. No.: US 2005/0104305 A1
(43) Pub. Date: May 19, 2005

(54) Device for fixing handlebar of bicycle which is mounted on rack of motor vehicle

(76) Inventor: Chao-Kuang Chan, Nantou (TW)

Correspondence Address: LAW OFFICE OF LIAUH & ASSOC., 4224 WAIALAE AVE, STE 5-388, HONOLULU, HI, 96816, US

(21) Appl. No.: 10/717,949

(22) Filed: Nov. 19, 2003

(51) Int. Cl. B62K 13/00

(52) U.S. Cl. 280/7.11

(57) ABSTRACT

A device is used to fix the stem of a bicycle which is transported by a vehicle. The device comprises an expandable rod and two holders which are fastened respectively at two opposite ends of the expandable rod, with the first holder being used to fix the stem of the bicycle in con junction with a confinement rod and a fastening knob, and with the second holder being fastened with the seat post of the bicycle in conjunction with a confinement rod and a fastening knob. The first holder is further provided with a restraining piece which is used to confine a handlebar fastened with the stem of the bicycle.

### FIELD OF THE INVENTION

The present invention relates to a device for securing the handlebar of a bicycle which is fastened to the rack of a motor vehicle, thereby preventing the handlebar from turning so as to ensure the safety of transporting the bicycle.

### BACKGROUND OF THE INVENTION

As shown in FIG. 1, a prior art device is used to fix the handlebar of a bicycle which is transported by a motor vehicle. The device comprises an expandable rod 1 and two U-shaped holders 2 which are respectively fastened to two ends of the expandable rod 1. The U-shaped holders 2 are provided in two arms thereof with a through hole 3. One of these two holders 2 is used to fix a bicycle stem 7, so as to prevent the handlebar from turning while the bicycle is mounted on the rack of a motor vehicle. As illustrated in FIG. 2, the bicycle stem 7 is fixed by the U-shaped holder 2 in conjunction with a pin 4 and a retaining piece 5, with another U-shaped holder 2 being fastened with the bicycle seat post 6. This prior art device can not be easily fastened and unfastened.

As shown in FIGS. 3 and 4, the Taiwan Pat. Serial No.90208567 discloses a device for fixing the handlebar of a bicycle which is mounted on the rack of a motor vehicle. The device comprises an expandable rod 10 and two holders 11 fastened respectively at two ends of the expandable rod 10. The expandable rod 10 is provided with a retaining edge 12 and a guide slot 13 extending along the longitudinal direction of the expandable rod 10. The expandable rod 10 is provided at two longitudinal ends with a slidable sleeve 14 capable of sliding along the longitudinal direction of the expandable rod 10 in conjunction with a locating bolt 15. The sleeve 14 is provided with a retaining slot 16 into which the retaining edge 12 is inserted for locating the sleeve 14. The slidable sleeve 14 is provided with an insertion piece 17 which is engageable with the holder 11.

As shown in FIGS. 5 and 6, the insertion piece 17 can be engaged or disengaged with the holder 11. When the insertion piece 17 is engaged with the holder 11, the retaining edge 12 is located in the retaining slot 16 of the slidable sleeve 14. When the retaining edge 12 is pressed with finger, the retaining edge 12 is caused to separate from the retaining slot 16, thereby enabling the sleeve 14 to slide along the expandable rod 10. As a result, the insertion piece 17 is caused to become disengaged with the holder 11, so as to enable a bicycle stem or seat post to be fastened with the holder 11. This prior art device is relatively complicated in construction and is therefore not cost-effective. In addition, the retaining edge 12 is susceptible to fatigue due to the repeated usage.

### SUMMARY OF THE INVENTION

The primary objective of the present invention is to provide an improved device free from the deficiencies of the prior art devices described above.

In keeping with the principle of the present invention, the foregoing objective of the present invention is attained by a device which is used to fixed the handlebar of a bicycle while the bicycle is being transported by a motor vehicle. The device comprises an expandable rod and two U-shaped holders which are respectively fastened at two longitudinal ends of the expandable rod. The U-shaped holders have two arms, one of which is provided at a free end with a confinement rod pivoted therewith. Other one of the two arms is provided at a free end with a fitting slot and a stop portion. The U-shaped holder is used to secure the stem of the bicycle in conjunction with a fastening knob.

The features and the advantages of the present invention will be more readily understood upon a thoughtful deliberation of the following detailed description of the present invention with reference to the accompanying drawings.

### BRIEF DESCRIPTION OF THE DRAWINGS

FIG. 1 shows an exploded view of a first prior art device.

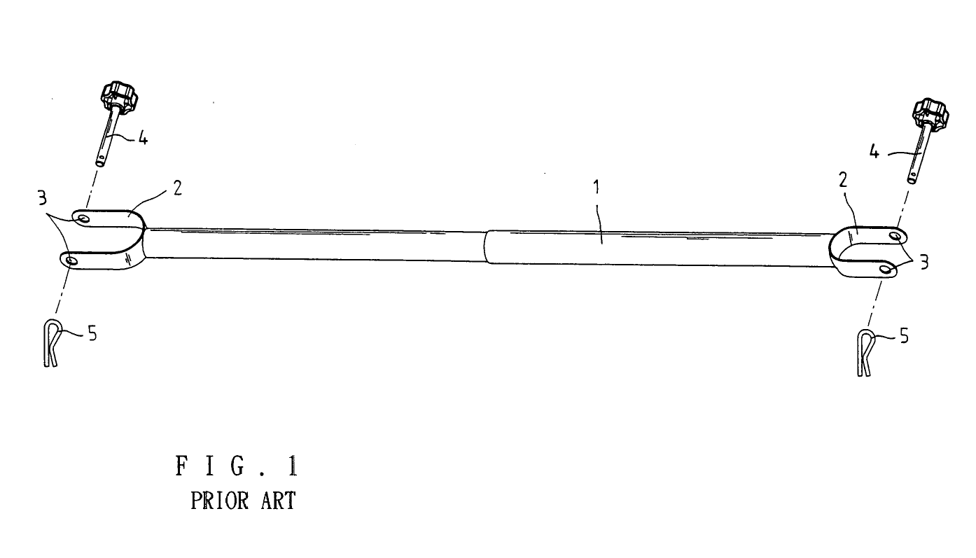

FIG. 2 shows a schematic view of the first prior art device at work.

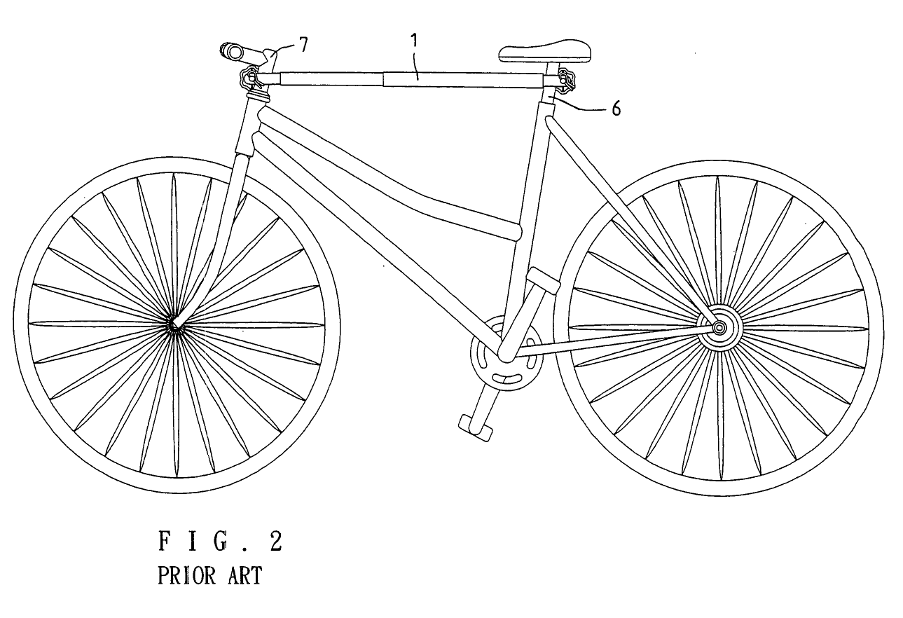

FIG. 3 shows an exploded view of a second prior art device.

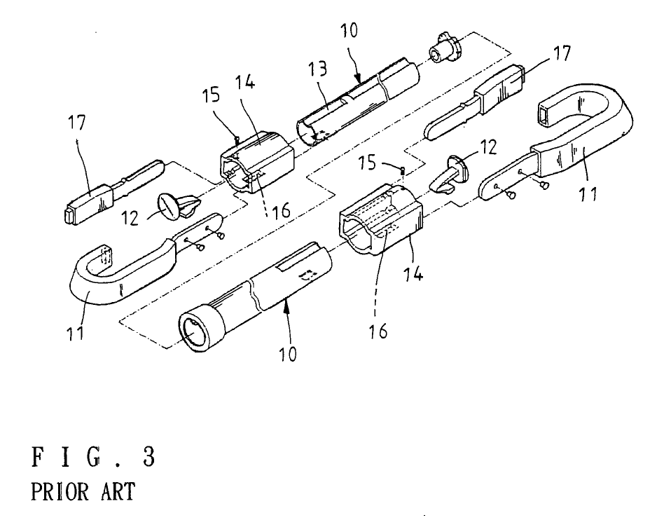

FIG. 4 shows a perspective view of the second prior art device in combination.

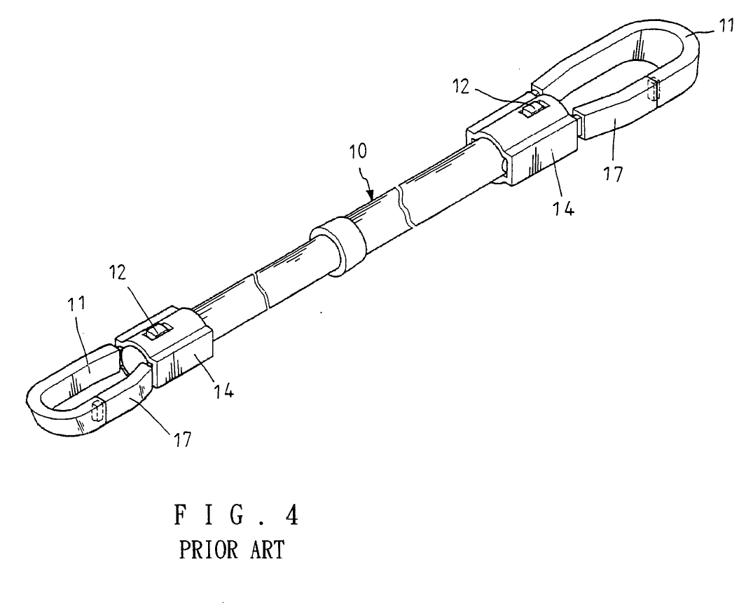

FIG. 5 shows a schematic view of the second prior art device at work.

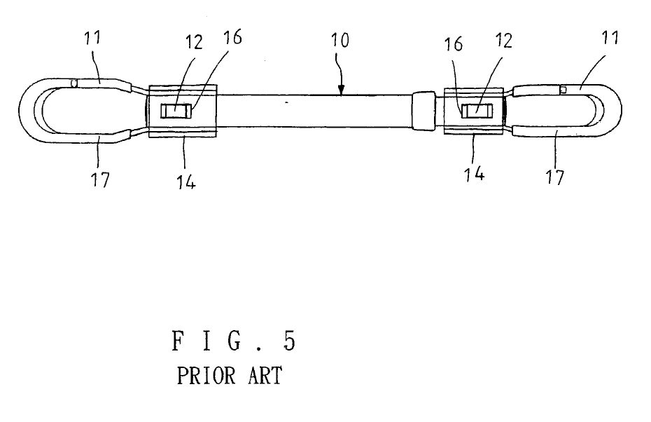

FIG. 6 shows another schematic view of the second prior art device at work.

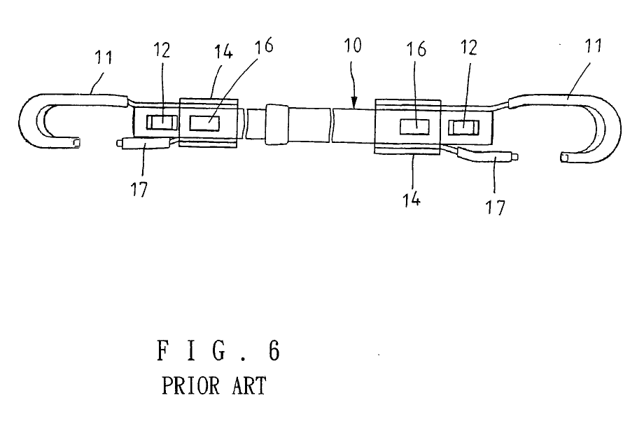

FIG. 7 shows a schematic view of a first preferred embodiment of the present invention.

FIG. 8 shows another schematic view of the first preferred embodiment of the present invention.

FIG. 9 shows a schematic view of the first preferred embodiment of the present invention at work.

FIG. 10 shows another schematic view of the first preferred embodiment of the present invention at work.

FIG. 11 shows an exploded view of a second preferred embodiment of the present invention.

FIG. 12 shows a perspective view of the second preferred embodiment of the present invention in combination.

FIG. 13 shows a schematic view of the second preferred embodiment of the present invention at work.

### DETAILED DESCRIPTION OF THE PREFERRED EMBODIMENTS

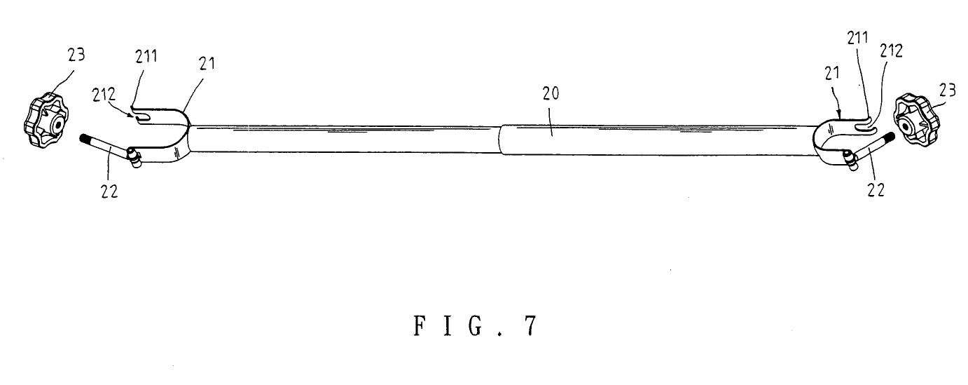

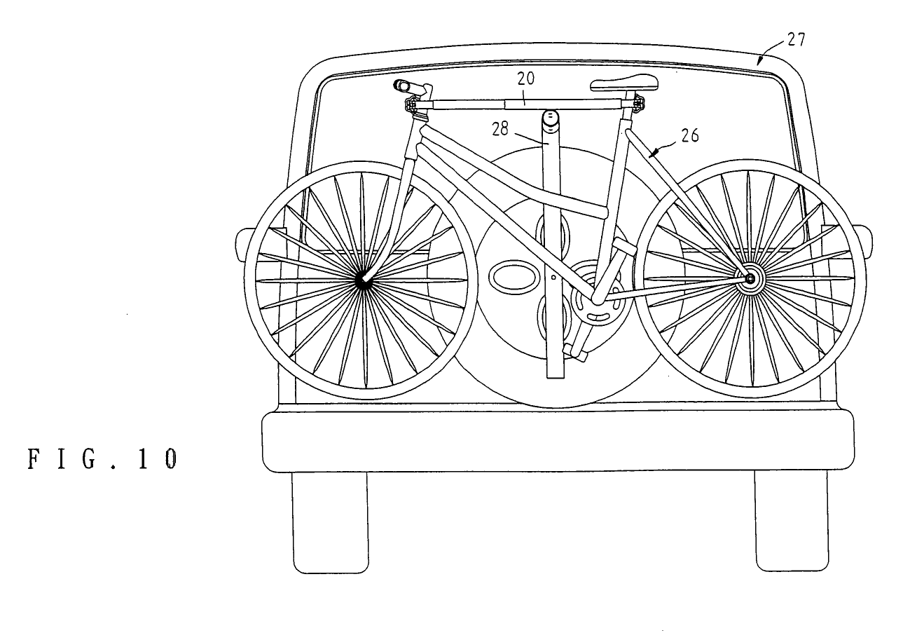

As shown in FIGS. 7-10, a device embodied in the present invention is used to fix the stem 24 of a bicycle 26 which is fastened to a rack 28 of a motor vehicle 27. The fixation of the stem 24 is intended to prevent the handlebar of the bicycle 26 from turning back and forth while the bicycle 26 is being transported by the motor vehicle 27.

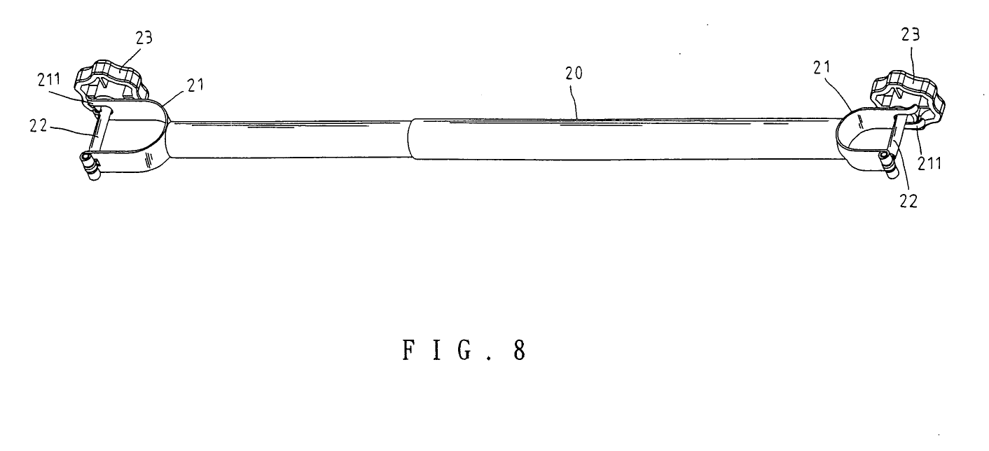

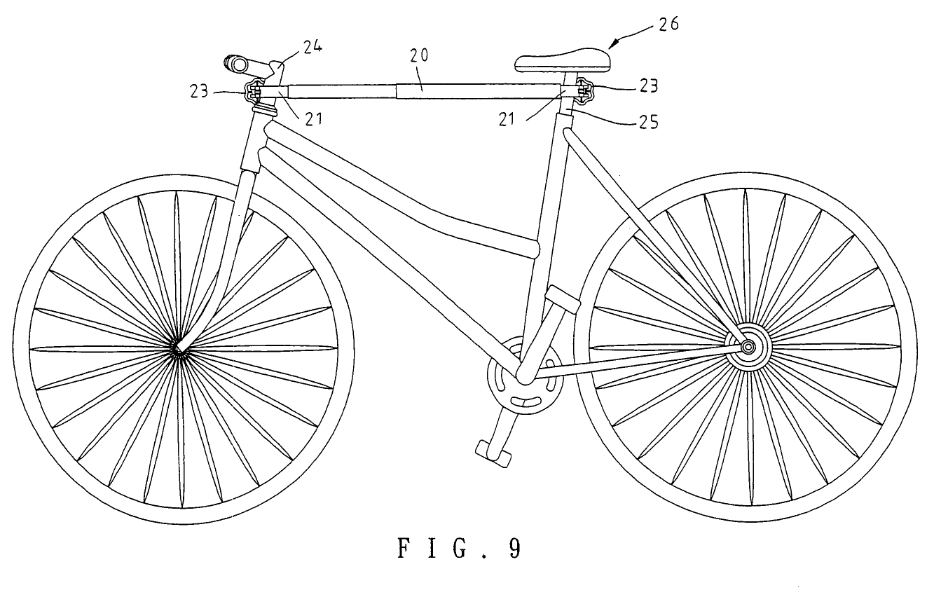

The device of the present invention comprises an expandable rod 20, and two holders 21 which are respectively fastened with two longitudinal ends of the expandable rod 20. One of the two holders 21 is used to fix the stem 24 while other one of the two holders 21 is fastened with a seat post 25 of the bicycle 26, as shown in FIG. 9. The two holders 21 are identical in construction to each other and are of a U-shaped construction. Each holder 21 has two arms, one of which is provided at a free end thereof with a confinement rod 22. The confinement rod 22 is pivoted at one end with the free end of one arm of the holder 21. Other one of the two arms is provided at a free end thereof with a stop portion 211 and a fitting slot 212 in which other end of the confinement rod 22 is releasably located in conjunction with a fastening knob 23. The fastening knob 23 is engaged with other end of the confinement rod 22, as shown in FIG. 8. The other end of the confinement rod 22 is prevented from slipping out of the fitting slot 212 by the fastening knob 23 and the stop portion 211.

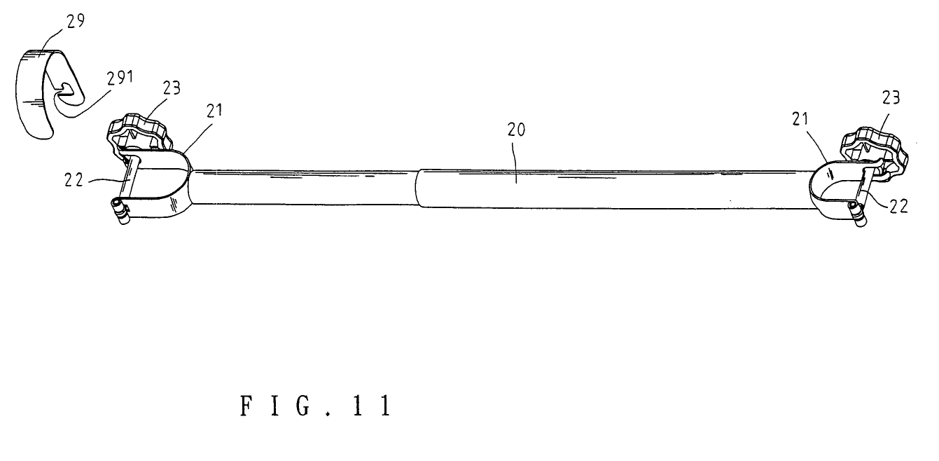

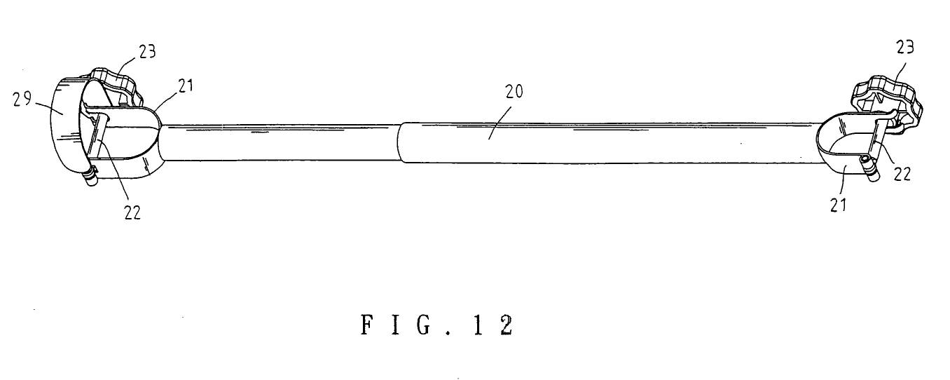

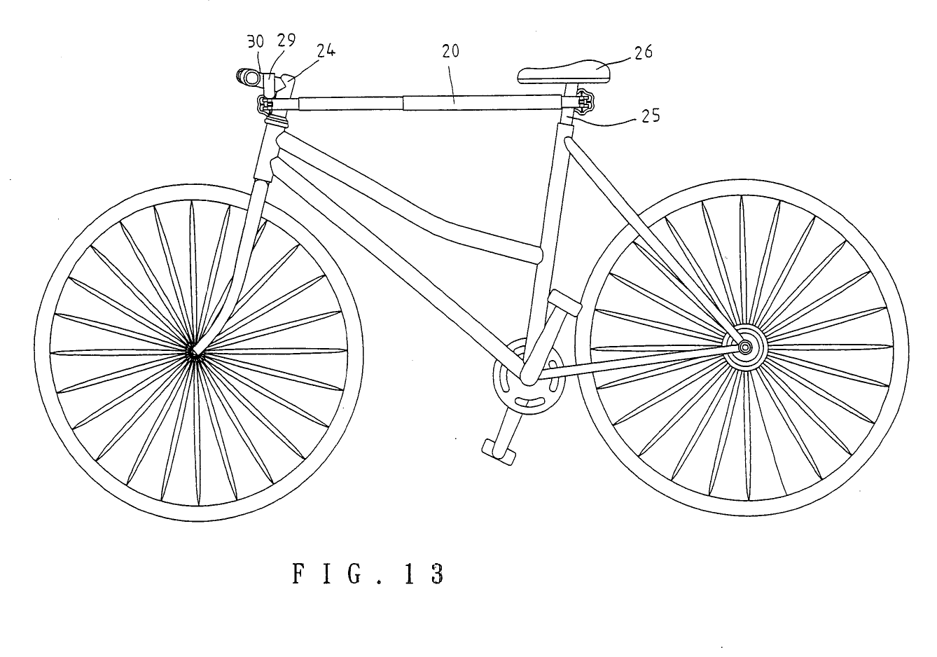

As shown in FIGS. 11-13, one of the two holders 21 of the device of the present invention is provided with a restraining piece 29 which is provided at one end with an L-shaped guide slot 291 engageable with other end of the confinement rod 22. The restraining piece 29 is intended to confine the handlebar 30 of the bicycle 26, as shown in FIG. 13. The restraining piece 29 serves as an enhancement device.

The embodiments of the present invention described above are to be regarded in all respects as being illustrative and nonrestrictive. Accordingly, the present invention may be embodied in other specific forms without deviating from the spirit thereof. The present invention is therefore to be limited only by the scopes of the following claims.

1. A device for fixing the stem of a bicycle which is transported by a vehicle, said device comprising:
an expandable rod;
a first holder fastened with one end of the expandable rod for fixing the stem of the bicycle; and
a second holder fastened with other end of the expandable rod for fastening with the seat post of the bicycle;
wherein said first holder and said second holder are of a U-shaped construction and are provided at a free end of one arm thereof with a confinement rod which is pivoted at one end thereof with the free end of the one arm, said confinement rod having other end which is engageable with a fastening knob, said first holder and said second holder being provided at a free end of other arm thereof with a slot for locating releasably the other end of said confinement rod.

2. The device as defined in claim 1, wherein the free end of the other arm of said first holder and said second holder is provided with a stop portion for preventing the other end of said confinement rod from moving out of said slot at the time when the other end of said confinement rod is located in said slot.

3. The device as defined in claim 1, wherein said first holder is provided with a restraining piece movably fastened therewith whereby said restraining piece is used to confine a handlebar which is fastened with the stem of the bicycle.

4. The device as defined in claim 3, wherein said restraining piece is provided at one end with a guide slot engageable with the other end of said confinement rod in such a manner that said restraining piece is located by said fastening knob.
